(19) United States
(12) Patent Application Publication
(10) Pub. No.: US 2025/0145371 A1
(43) Pub. Date: May 8, 2025

(54) REFUSE LIFT ARM ASSEMBLY

(71) Applicant: The Heil Co., Chattanooga, TN (US)

(72) Inventors: Hugo Vega, Fort Payne, AL (US); Mark Fraas, Centre, AL (US)

(21) Appl. No.: 18/749,147

(22) Filed: Jun. 20, 2024

Related U.S. Application Data
(60) Provisional application No. 63/597,297, filed on Nov. 8, 2023.

(51) Int. Cl. B65F 3/04

(52) U.S. Cl. CPC B65F 3/046

(57) ABSTRACT

The refuse lift arm system includes a grabber device configured to engage the refuse container and a container lift. The container lift includes a carriage, a rail assembly, and a tipping mechanism. The carriage supports pivotal movement of the grabber device. The rail assembly supports translational movement of the carriage. The tipping mechanism is configured to pivot the grabber device relative to the carriage in response to relative movement between the carriage and the rail assembly. The refuse lift arm system further includes a horizontal positioning system configured to move the rail assembly laterally relative to the refuse collection vehicle.

### CROSS-REFERENCE TO RELATED APPLICATIONS

This application claims the benefit under 35 U.S.C. § 119(e) of U.S. Patent Application No. 63/597,297, entitled “Refuse Lift Arm System,” filed Nov. 8, 2023, which is incorporated herein by reference in its entirety.

### TECHNICAL FIELD

This disclosure relates to the field of refuse collection vehicles.

### BACKGROUND

Refuse collection vehicles are typically used to pick up quantities of refuse (e.g., garbage, waste, recyclables, etc.) for hauling to a determined area, such as a landfill, transfer station, or material recovery facility. Some refuse collection vehicles include loading mechanisms to assist in loading refuse or other materials into the refuse collection vehicle.

### SUMMARY

Some implementations of this disclosure feature a refuse lift arm system for engaging a refuse container proximate a refuse collection vehicle. The refuse lift arm system includes a grabber device configured to engage the refuse container and a container lift. The container lift includes a carriage supporting pivotal movement of the grabber device and a rail assembly supporting translational movement of the carriage. The container lift further includes a lift drive mechanism and a tipping mechanism. The lift drive mechanism is coupled to the carriage and the rail assembly. The lift drive is configured to drive the carriage to translate along the rail assembly between a lowered position and a raised position. The tipping mechanism is configured to pivot the grabber device relative to the carriage until the grabber device reaches a tipped condition. The tipping mechanism includes a rack fixed to the rail assembly and a pivot gear fixed to the grabber device and rotatably mounted to the carriage. The pivot gear is configured to engage the rack and rotate relative to the carriage as the carriage moves along the rail assembly toward the raised position.

In some implementations, the refuse lift arm system further includes a horizontal positioning system coupled to the rail assembly and configured to move the rail assembly laterally relative to the refuse collection vehicle.

In some implementations, the pivot gear includes a first section with a plurality of gear teeth and a second section fixed to a bracket that attaches the pivot gear to the grabber device.

In some implementations, the rack includes a plurality of rack segments, each of the plurality of rack segments including one or more rack teeth. In some implementations, at least one of the plurality of rack segments is removable from the rail assembly independent of at least one other of the plurality of rack segments.

In some implementations, the rail assembly includes at least one lateral bend having a tilt angle between 5 and 12 degrees relative to a vertical plane. In some implementations, the at least one lateral bend includes two lateral bends, and the tilt angle of each of the lateral bends is in the same angular direction relative to the vertical plane.

In some implementations, the lift drive mechanism includes a tether and a drive unit. The tether is supported on the rail assembly and coupled to the carriage. The drive unit is configured to drive movement of the tether relative to the rail assembly. In some implementations, wherein the drive unit includes an electric motor. In some implementations, the tether includes a timing belt and the timing belt is supported on the rail assembly by a pair of timing belt pulleys rotatably mounted to the rail assembly. In some implementations, the timing belt and the pair of timing belt pulleys are part of a first timing belt system. Additionally, the system further includes a second timing belt system, and the drive unit is configured to simultaneously drive the first and second timing belt systems.

In some implementations, the refuse lift system further includes a sensor and a controller. The sensor is configured to detect relative movement of the grabber device. The controller is configured to receive data from the sensor, determine a proximity of the grabber device to at least one other component of the system, and control operation of the lift drive mechanism based on the determined proximity. In some implementations, the controller is configured to control operation of the lift drive mechanism by reducing a speed of upward movement of the carriage along the rail assembly.

Some implementations of this disclosure feature a method of emptying refuse from a refuse container. The method includes the step of holding a refuse container with a grabber device. While the grabber device is holding the refuse container, the method further includes the steps of [i] moving the grabber device toward a raised position until a pivot gear engages a rack; and [ii] tipping the grabber device by continuing to move the grabber device toward the raised position as the pivot gear rotates and traverses the rack.

In some implementations, moving the grabber device toward the raised position includes operating a drive mechanism to drive the grabber device upward while supported on a rail of a rail assembly.

In some implementations, the method further includes the step of determining a relative position of the grabber device. In some implementations, the method stiff further includes the steps of [i] determining that the pivot gear is approaching the rack based on the relative position of the grabber device; and [ii] in response to determining that the pivot gear is approaching the rack, reducing a speed of movement of the grabber device toward the raised position.

Some implementations of this disclosure feature a refuse lift arm system for engaging a refuse container proximate a refuse collection vehicle. The refuse lift arm system includes a grabber device configured to engage the refuse container and a container lift. The container lift includes a carriage, a rail assembly, and a tipping mechanism. The carriage supports pivotal movement of the grabber device. The rail assembly supports translational movement of the carriage. The tipping mechanism is configured to pivot the grabber device relative to the carriage in response to relative movement between the carriage and the rail assembly. The refuse lift arm system further includes a horizontal positioning system configured to move the rail assembly laterally relative to the refuse collection vehicle. The horizontal positioning system includes a base section, an intermediate section, and a distal section. The horizontal positioning system further includes a horizontal drive mechanism including: [i] a first tether attached to the intermediate section; [ii] a second tether attached to the base section and the distal section; and [iii] a drive unit configured to drive movement of the first and second tethers.

In some implementations, the horizontal positioning system further includes a first belt system and a second belt system. The first belt system includes a first pair of pulleys spaced horizontally from one another and each rotatably coupled to the base section. The first belt system further includes a first timing belt including the first tether, the first timing belt looped around the first pair of pulleys. The second belt system includes a second pair of pulleys spaced horizontally from one another and each rotatably coupled to the intermediate section. The second belt system further includes a second timing belt including the second tether, the second timing belt looped around the second pair of pulleys.

Some implementations of this disclosure feature a refuse lift arm system for engaging a refuse container proximate a refuse collection vehicle. The refuse lift arm system includes a grabber device configured to engage the refuse container and a container lift. The container lift includes a carriage, a rail assembly, and a tipping mechanism. The carriage supports pivotal movement of the grabber device. The rail assembly supports translational movement of the carriage. The tipping mechanism is configured to pivot the grabber device relative to the carriage in response to relative movement between the carriage and the rail assembly. The refuse lift arm system further includes a horizontal positioning system configured to move the rail assembly laterally relative to the refuse collection vehicle. The horizontal positioning system includes a base section, an intermediate section, and a distal section. The horizontal positioning system further includes a first rocker-type roller assembly and a second rocker-type roller assembly. The first rocker-type roller assembly resides between an upper rail and a lower rail of the intermediate section. The first rocker-type roller assembly includes a first carrier pivotally secured to the distal section, a first upper roller rotatably mounted in the first carrier and placed in contact with the upper rail of the intermediate section, a first lower roller coupled to the first carrier by a first arm. The second rocker roller assembly resides between an upper rail and a lower rail of the base section. The second rocker-type roller assembly includes a second carrier pivotally secured to the intermediate section, a second upper roller rotatably mounted in the second carrier and placed in contact with the upper rail of the base section, and a second lower roller coupled to the second carrier by a second arm.

Particular implementations of the subject matter described in this specification can be implemented so as to realize one or more material advantages. For example, certain implementations provide a refuse lift arm system that is inexpensive to manufacture and maintain, occupies a compact volume envelope, is energy efficient, and is relatively easy to service (e.g., by repairing and replacing worn components).

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a refuse collection vehicle featuring a refuse lift arm system.

FIG. 2 is a perspective view of a refuse lift arm system including a grabber device in a lowered position.

FIG. 3 is a perspective view of a refuse lift arm system including a grabber device in a raised and tipped condition.

FIG. 4 is a perspective view of a container lift of a refuse lift arm system.

FIG. 5 is a side view of a rail assembly of a container lift.

FIG. 6 is a top view of a rail assembly of a container lift.

FIG. 7 is a rear perspective view of the bottom portion of a container lift.

FIG. 8 is a perspective view of a portion of a refuse lift arm system including a tipping mechanism.

FIG. 9 is a side view of a portion of a refuse lift arm system including a tipping mechanism.

FIG. 10 is a cross-sectional side view of a refuse lift arm system including a tipping mechanism.

FIG. 11 is a detail view of the tipping mechanism shown in FIG. 10.

FIG. 12 is a side view of a portion of a refuse lift arm system including a grabber device in a lowered position.

FIG. 13 is a perspective view of a horizontal positioning system for a refuse lift arm system in a retracted state.

FIG. 14 is a perspective view of a horizontal positioning system for a refuse lift arm system in an extended state.

FIGS. 15A and 15B are cross-sectional side views of a horizontal positioning system for a refuse lift arm system in alternative retracted and extended states.

FIG. 16 is a wireframe perspective view of a horizontal positioning system for a refuse lift arm system.

FIG. 17 is a perspective cross-sectional side view of a first internal roller assembly of a horizontal positioning system for a refuse lift arm system.

FIG. 18 is a rear perspective cross-sectional view of a second internal roller assembly of a horizontal positioning system for a refuse lift arm system.

FIGS. 19, 20, and 21 are perspective and side views a horizontal positioning system for a refuse lift arm system featuring hydraulic actuators.

FIG. 22 depicts an example computing system in accordance with various implementations of the present disclosure.

### DETAILED DESCRIPTION

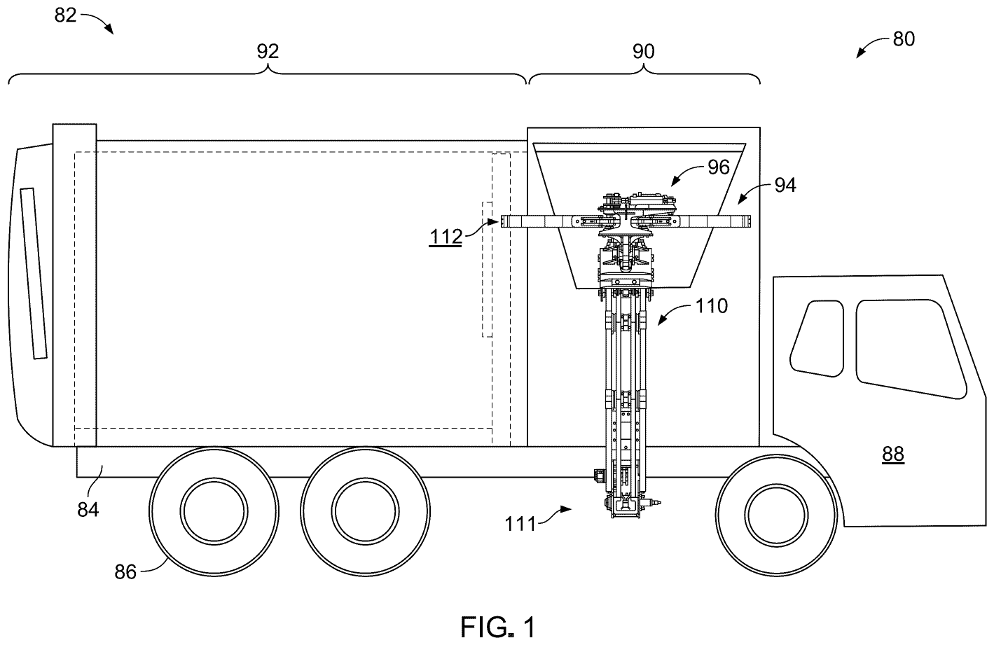

FIG. 1 illustrates a refuse collection vehicle 80. Refuse collection vehicle 80 is operable to collect, optionally pack, and transport refuse to a determined area, such as a landfill, transfer station, or material recovery facility.

Refuse collection vehicle 80 includes waste collection device 82, frame 84, wheels 86, and cab 88. Waste collection device 82 includes waste intake portion 90 and waste storage portion 92. Waste intake portion 90 includes refuse loading system 94 and hopper 96. Refuse loading system 94 is operable to transfer the contents of refuse containers into waste storage portion 92 via hopper 96. In some implementations, waste collection device 82 further includes a packer (not shown) operable to pack refuse loaded into hopper 96, push refuse toward the rear of the refuse collection vehicle 80 (e.g., to waste storage portion 92), and/or eject refuse from the refuse collection vehicle 80.

Refuse loading system 94 includes refuse lift arm system 110. Refuse lift arm system 110 includes container lift 111 and grabber device 112. Grabber device 112 is operable to engage (e.g., grasp) a refuse container located proximate refuse collection vehicle 80. Container lift 111 is operable to lift the refuse container and to tip and dump the contents of the refuse container into hopper 96.

In some implementations, refuse collection vehicle 80 is an all-electric vehicle or an at least partially electric vehicle. For example, one or more (e.g., all) motive power elements, body controls, and sub-systems of refuse collection vehicle 80 (including refuse loading system 94, a packing system, an ejector system, a contamination detection system) can be electrically powered by onboard battery packs.

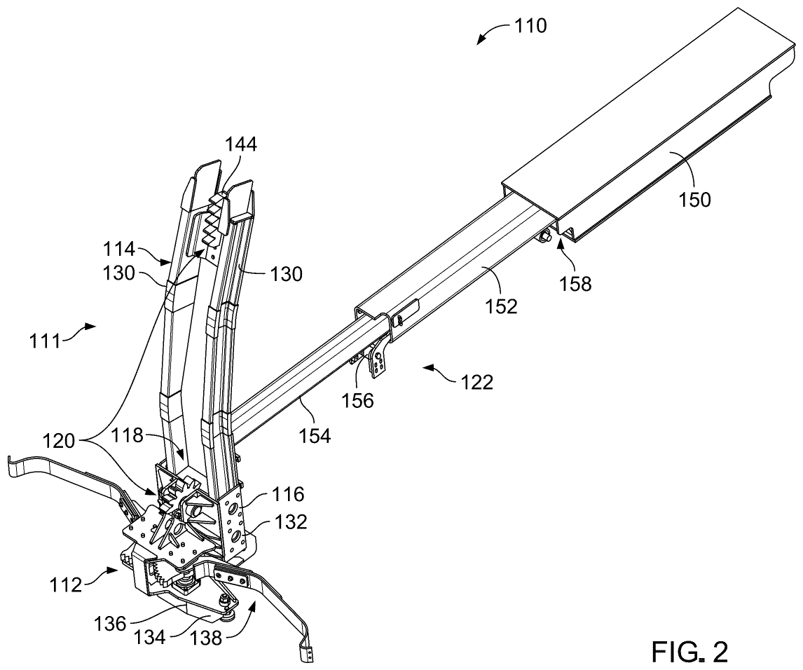

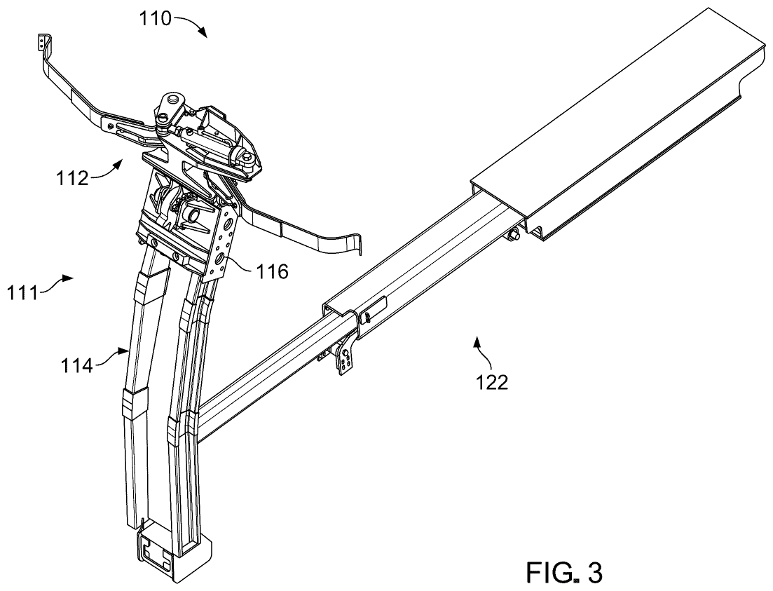

As shown in FIG. 2, refuse lift arm system 110 includes grabber device 112, container lift 111, and horizontal positioning system 122. Refuse lift arm system 110 is operable to engage a refuse container, to lift the refuse container, and to tip and empty the contents of the refuse container into a bin or hopper of a refuse collection vehicle to which refuse lift arm system is attached. FIG. 3 illustrates refuse lift arm system 110 with grabber device 112 in a raised and tipped condition. While the arms of grabber device 112 are open in FIG. 3, in operation, the arms could be closed to engage a refuse container.

Container lift 111 includes carriage 116, rail assembly 114, lift drive mechanism 118, and tipping mechanism 120.

Carriage 116 is coupled to grabber device 112. Carriage 116 is also coupled to rail assembly 114 and operable to translate (e.g., move up and down) along the extent of rail assembly 114 between a raised position and a lowered position. In this example, rail assembly 114 includes left and right rails 130. Carriage 116 includes rollers 132 that engage the left and right rails 130 of rail assembly 114 to facilitate the translating movement of carriage 116.

Lift drive mechanism 118 resides (at least partially) between the left and right rails 130 of rail assembly 114. Lift drive mechanism 118 is operable to drive carriage 116, and thus grabber device 112, to move along rail assembly 114 via the engaged rollers 132 and left and right rails 130. In some implementations, lift drive mechanism 118 includes an electric motor. In some implementations, lift drive mechanism 118 includes a hydraulic actuator. In some implementations, lift drive mechanism 118 includes a linear actuator.

Grabber device 112 is pivotally coupled to carriage 116. As discussed further below, grabber device 112 is supported and carried by carriage 116, and grabber device 112 can also rotate about a pivot axis relative to carriage 116. Grabber device 112 includes body 134, grabber drive mechanism 136, and arms 138. Grabber drive mechanism 136 is operable to open and close arms 138 to engage and hold a refuse container. In some implementations, grabber drive mechanism 136 includes an electric motor. In some implementations, grabber drive mechanism 136 includes a hydraulic actuator.

During a lift cycle, when grabber device 112 is raised near the top of rail assembly 114, grabber device 112 pivots on carriage 116 such that a refuse container held by grabber device 112 is tipped. With the refuse container tipped, the contents of the refuse container are emptied into the hopper or storage container of the refuse collection vehicle.

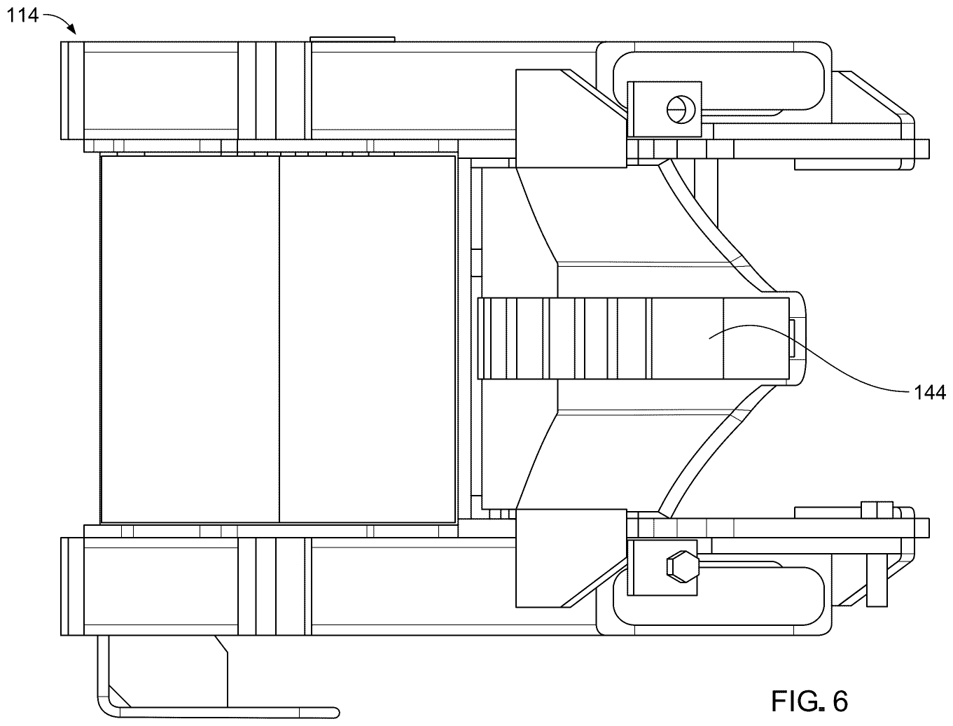

Tipping mechanism 120 includes pivot gear 142 and rack 144. Pivot gear 142 is fixed to grabber device 112 and rotatably mounted to carriage 116. Rack 144 is fixed at a position near the top of rail assembly 114 between the left and right rails 130 (see, e.g., top view of FIG. 6). During a lift cycle (referenced above), carriage 116 translates upward on rail assembly 114 while carrying grabber device 112 and pivot gear 142, causing pivot gear 142 to engage rack 144. The engagement between pivot gear 142 and rack 144 combined with the upward movement of carriage 116 causes grabber device 112 (and thus the refuse container held by grabber device 112) to tip toward the hopper or storage container of the refuse collection vehicle.

Rail assembly 114 is coupled to a refuse collection vehicle by a horizontal positioning system 122. Horizontal positioning system 122 includes multiple telescoping sections that move container lift 111 and grabber device 112 toward or away from the refuse collection vehicle.

As shown in FIG. 2, horizontal positioning system 122 includes three telescoping sections, including base section 150, which is secured to the refuse collection vehicle, distal section 154, which is secured to container lift 111, and intermediate section 152, which couples base section 150 to distal section 154. Horizontal positioning system 122 further includes external rollers 156, internal rollers (discussed below), and drive mechanism 158 to facilitate relative movement between the sections. Drive mechanism 158 imparts motion (e.g., provides sufficient motive force and torque) to extend and retract the telescoping sections 150, 152, 154, such that container lift 111 and grabber device 112 are moved toward or away from the refuse collection vehicle.

In some implementations, a single drive mechanism drives the motion of both intermediate section 152 and distal section 154 relative to base section 150. In other implementations, a separate drive mechanism is provided to impart motion to each of intermediate section 152 and distal section 154 relative to one another and relative to base section 150. In some implementations, drive mechanism 158 includes one or more electric motors. In some implementations, drive mechanism 158 includes one or more hydraulic actuators. In some implementations, drive mechanism 158 includes one or more linear actuators.

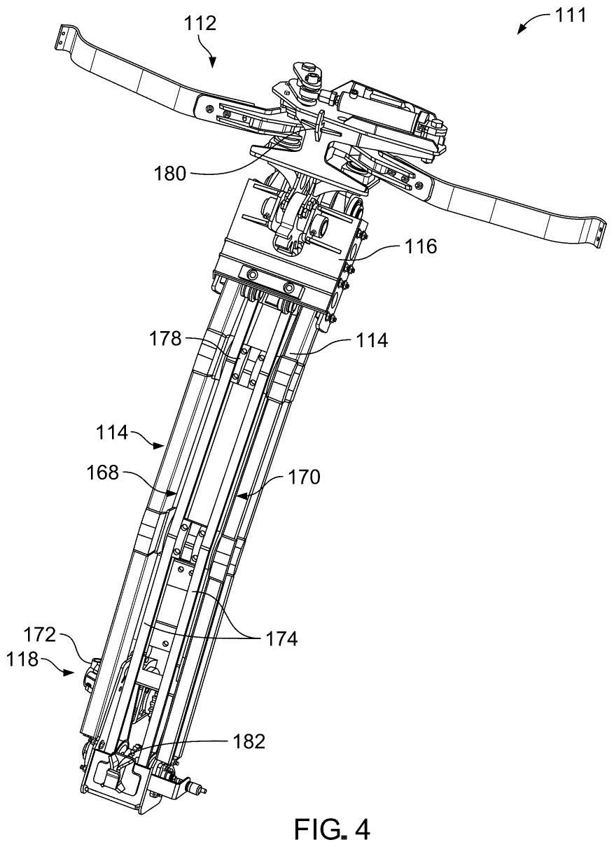

As shown in FIG. 4 and consistent with the discussion above, the lift drive mechanism 118 of container lift 111 includes left timing belt system 168, right timing belt system 170, and drive unit 172. Left timing belt system 168 and right timing belt system 170 each include an upper timing pulley and a lower timing pulley rotatably coupled to rail assembly 114. A respective timing belt 174 is arranged in a loop on each of the pairs of timing pulleys. Carriage 116 is attached to each of the respective timing belts 174. Drive unit 172 is coupled to drive the rotation of each of the lower pulleys of left timing belt system 168 and right timing belt system 170. Rotation of the lower pulleys causes timing belts 174 to move (e.g., sliding movement along low-friction pads 178), which drives translation of carriage 116 along rail assembly 114.

Still referring to FIG. 4, grabber device 112 includes a projection 180. When grabber device 112 is in a lowered position, projection 180 engages (e.g., at least partially extends into) a receptacle 182 at the bottom of rail assembly 114. Engagement of projection 180 with receptacle 182 can inhibit (e.g., prevent) operative movement of grabber device 112.

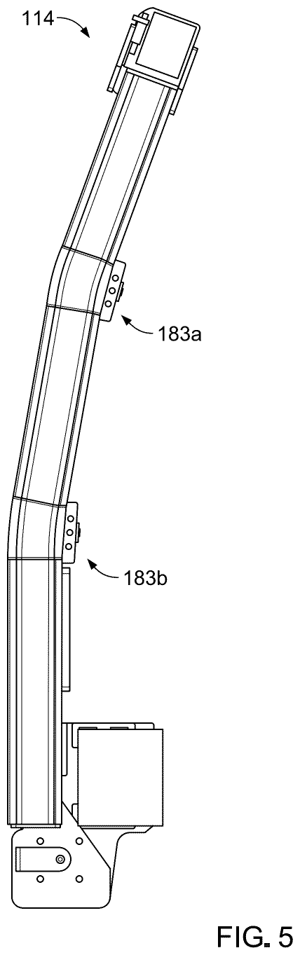

As shown in FIG. 5, rail assembly 114 includes two lateral bends 183a, 183b along its length. In some implementations, lateral bends 183a, 183b have a tilt angle relative to a vertical plane of between 2 and 17 degrees, such as between 5 and 12 degrees, and/or about 10 degrees. The term “about” in this disclosure, when used to describe a numerical range or value, references a margin within ±5% of the stated value or range. In some implementations, lateral bends 183a, 183b have a substantially similar (e.g., within ±5%) tilt angle. In some implementations, one of lateral bends 183a, 183b has a larger tilt angle than the other lateral bend. In some implementations, a rail assembly can include no lateral bends, only one lateral bend, or more than two lateral bends.

In this example, the tilt angle of each of lateral bends 183a, 183b is in the same angular direction, such that the top portion of rail assembly 114 extends laterally from the lower portion of rail assembly 114, closer to the refuse collection vehicle. Accordingly, lateral bends 183a, 183b allow grabber device 112 to position the refuse container closer to a hopper or storage container of the vehicle when tipped. That is, during a dump cycle, as carriage 116 moves upward along rail assembly 114 along with grabber device 112 and the refuse container, all three objects move laterally closer to the refuse collection vehicle. This way, when the grabber device 112 and refuse container are tipped, they are properly positioned over the hopper or storage container.

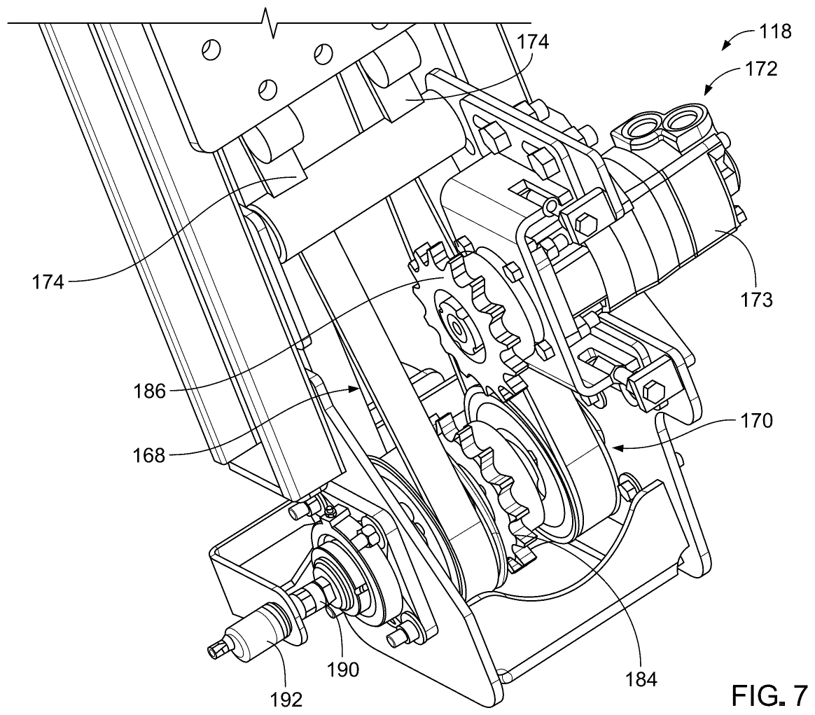

As shown in FIG. 7 and discussed above with reference to FIG. 4, lift drive mechanism 118 includes left timing belt system 168, right timing belt system 170, and drive unit 172. Lift drive mechanism 118 further includes drive sprocket 184, driven sprocket 186, and a drive chain between them (omitted from FIG. 7 for clarity).

Drive unit 172 includes electric motor 173. Driven sprocket 186 and the lower timing pulleys of left timing belt system 168 and right timing belt system 170 are coupled to a common shaft 190. As discussed, drive unit 172 is operable to rotate the lower timing pulleys to raise and lower carriage 116 on rail assembly 114. Encoder 192 is coupled to shaft 190 and communicatively coupled to a controller. Encoder 192 can provide information to the controller about the position of carriage 116 on rail assembly 114 based on the detected position of shaft 190.

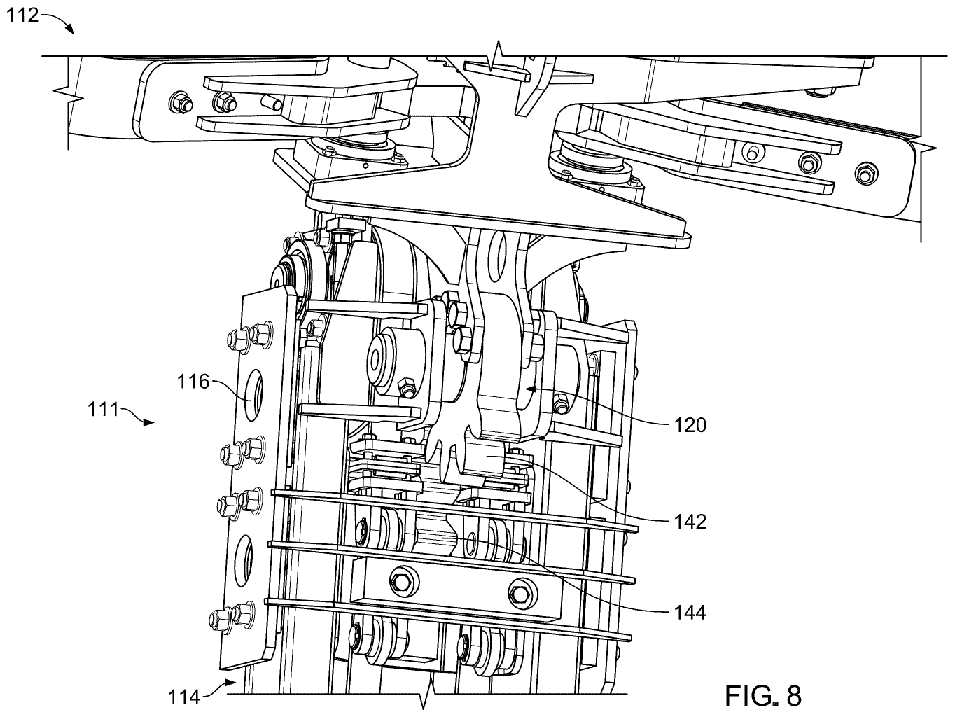

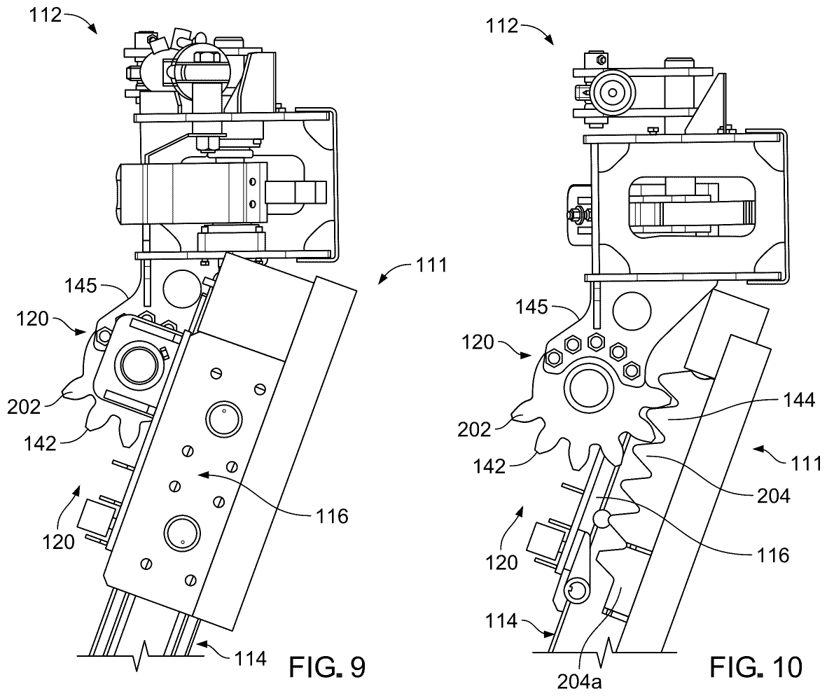

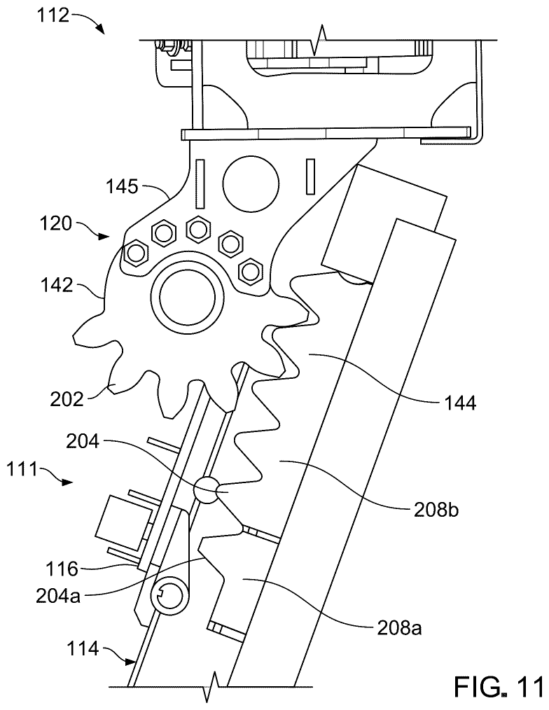

FIGS. 8-10 illustrate a portion of refuse lift arm system 110 in an operative state where container lift 111 (e.g., during a lift cycle) has moved carriage 116 and grabber device 112 to a raised position on rail assembly 114 that actuates tipping mechanism 120. As shown in FIGS. 8-10 (and consistent with the above discussion of tipping mechanism 120 in view of FIG. 2), actuating tipping mechanism 120 involves engaging pivot gear 142 with rack 144.

Recall that pivot gear 142 is fixed to grabber device 112. More specifically, pivot gear 142 is a sector-type gear featuring a first section with pivot gear teeth 202 and a remaining section fixed (e.g., fastened) to a bracket 145 that couples pivot gear 142 to grabber device 112. Accordingly, while carriage 116 is driven upward along rail assembly 114, pivot gear teeth 202 engage and advance along complementary rack teeth 204, causing pivot gear 142 to rotate relative to carriage 116. Because grabber device 112 is fixedly coupled to pivot gear 142, rotation of pivot gear 142 relative to carriage 116 causes grabber device 112 to progressively pivot (or tip) toward the refuse collection vehicle, which empties the contents of a refuse container held by grabber device 112.

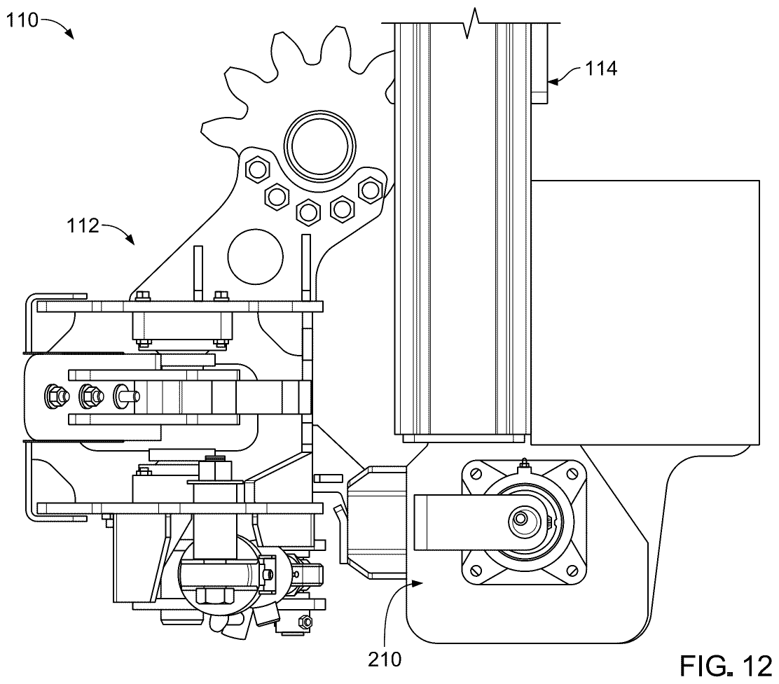

FIG. 11 illustrates the above-discussed components of tipping mechanism 120 in more detail. Initially, as carriage 116 rises along rail assembly 114, one of the pivot gear teeth 202 engages the leading rack tooth 204a of rack 144. As carriage 116 continues its upward movement, pivot gear teeth 202 engage successive rack teeth 204 in the manner described above until grabber device 112 reaches the raised and tipped condition.

In some implementations, tipping mechanism 120 includes a latch that inhibits or prevents downward movement of grabber device 112 on rail assembly 114 until the latch is released. In some implementations, rail assembly 114 includes a stop that inhibits tipping of grabber device 112 beyond a desired angle.

In some implementations, a controller is operably coupled to lift drive mechanism 118, grabber drive mechanism 136, drive mechanism 158, or any combination thereof. The controller can be operated to control the position of grabber device 112, as well as the open and/closure state of its arms. In some implementations, the controller alters the speed of ascent of carriage 116 when the teeth of pivot gear 142 are engaged or approaching engagement with the teeth of rack 144. For example, in one implementation, the rate of ascent on rail assembly 114 is reduced when the pivot gear 142 initially contacts lead rack gear tooth 204a. In some implementations, the rate of ascent on rail assembly 114 is reduced before the pivot gear 142 initially contacts lead rack gear tooth 204a (e.g., a predetermined distance or time before contact is estimated to occur). In some implementations, the rate of ascent is controlled to reduce impact and wear on the teeth of pivot gear 142 and rack 144.

In various implementations, rack 144 includes two or more segments. For example, as shown in FIG. 11, rack 144 includes two distinct rack segments 208a and 208b. Rack segments 208a and 208b can be separately removed and replaced. In some instances, one segment may be replaced more often than other segments to account for differences in wear on the respective rack teeth (e.g., wear rate, wear depth, wear pattern, etc.). For example, rack segment 208a may be replaced more often than rack segment 208b because lead rack tooth 204a experience more wear than other rack teeth, e.g., due to the initial impact between pivot gear 142 and rack 144. In some implementations, a damping material is provided between adjacent rack segments.

In some implementations, refuse lift arm system 110 includes one or more sensors that detect a position tipping state (e.g., tip angle) of grabber device 112, the position of carriage 116, or both, on rail assembly 114. In some implementations, the sensors include a proximity sensor coupled the controller. In some implementations, a drive mechanism includes one or more encoders that are coupled to the controller and provide information about the motor state to the controller. The encoder information can be used to control the motion and position of components in refuse lift arm system 110, such as grabber device 112.

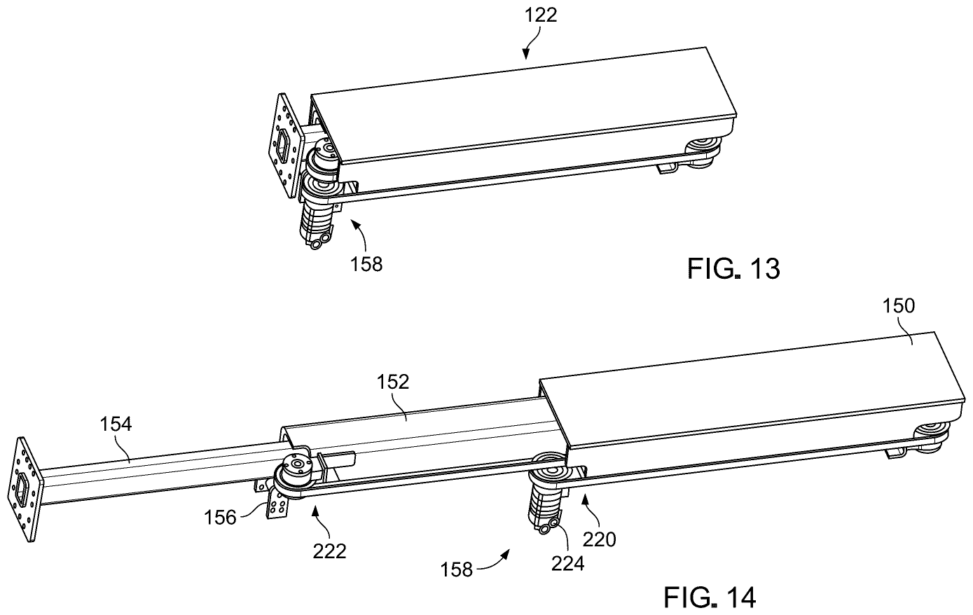

FIG. 12 is a side view of a portion of refuse lift arm system 110 illustrating grabber device 112 positioned at the bottom of rail assembly 114. As shown, refuse lift arm system 110 includes latch 210. Latch 210 can engage with carriage 116, grabber 112, or both, when grabber device 112 is at the bottom of rail assembly 114. Latch 210 can inhibit or prevent rotation of any or all of these components to preclude unintentional operations. In some implementations, latch 210 is a passive, hook-type latch.

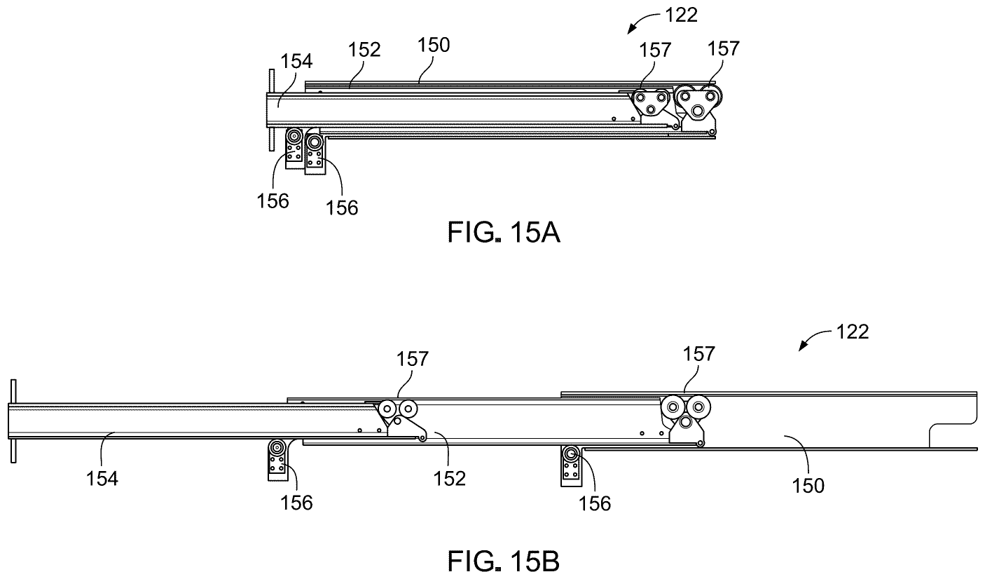

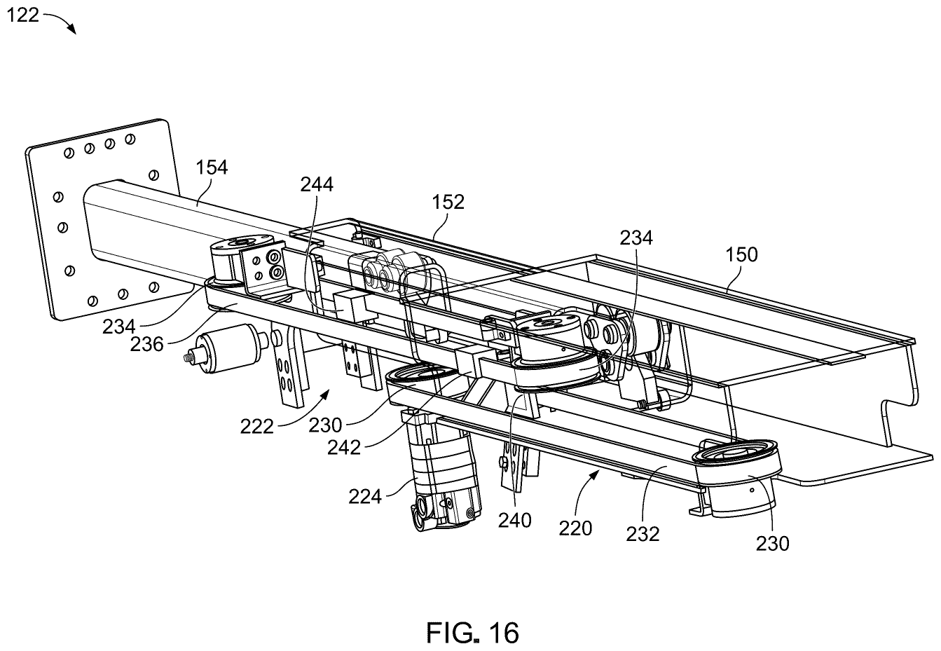

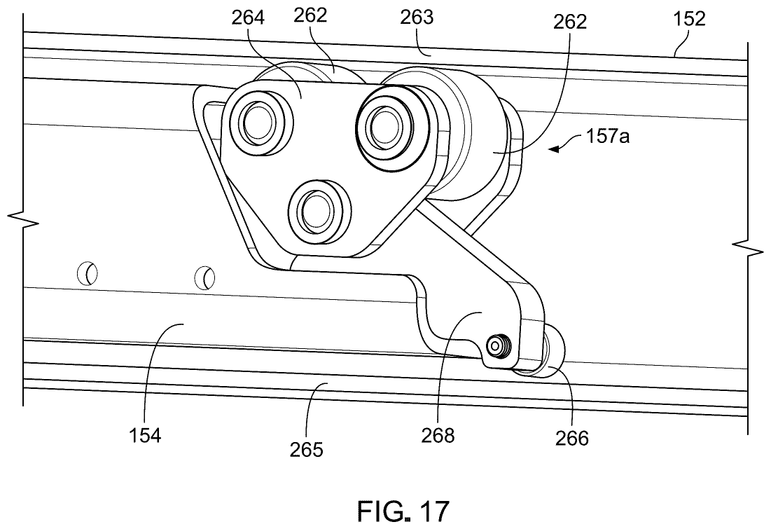

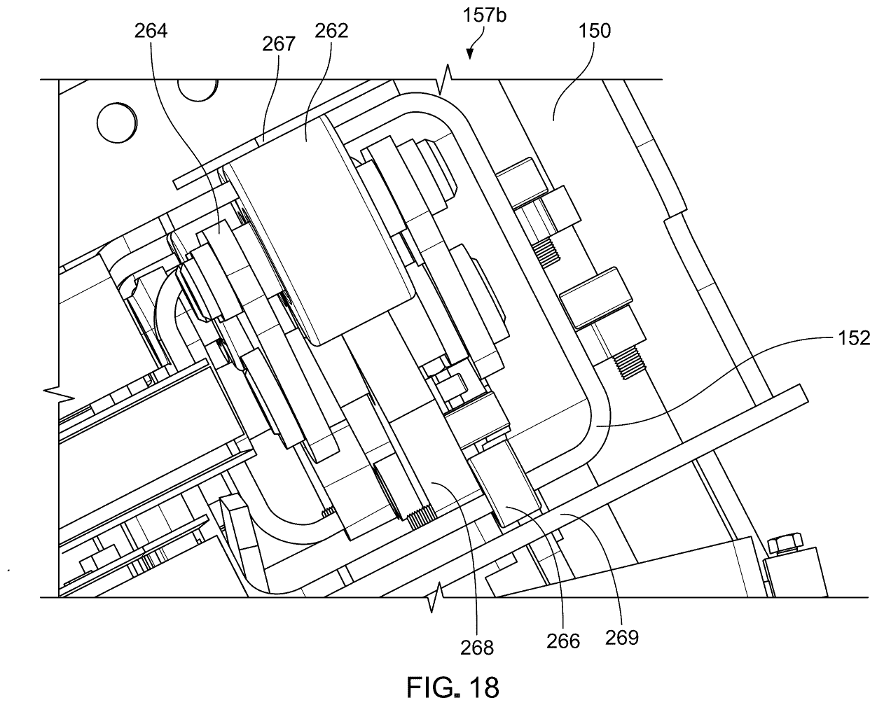

As shown in FIG. 13-16 (and consistent with the discussion above in view of FIG. 2), horizontal positioning system 122 transitions between a retracted state (which may occur, for example, when the refuse collection vehicle is in motion) and an extended state (which may occur, for example, when the refuse lift arm system 110 is being used to pick up a refuse container).

As discussed, horizontal positioning system 122 includes three sections, including base section 150, intermediate section 152, and distal section 154. Horizontal positioning system 122 also includes external rollers 156, internal rollers 157, and drive mechanism 158. Drive mechanism 158 imparts motion (e.g., provides sufficient motive force and torque) to extend and retract the telescoping sections 150, 152, 154, such that container lift 111 and grabber device 112 are moved toward or away from the refuse collection vehicle.

Referring specifically to FIGS. 13-14 and 16, drive mechanism 158 includes timing belt system 220, timing belt system 222, and horizontal drive unit 224. As described below, horizontal drive unit 224 is operable to drive the timing belt systems 220 and 222 such that distal section 154 and intermediate section 152 move in and out with respect to base section 150 (and with respect to the refuse collection vehicle to which the base section 150 is secured).

Timing belt system 220 includes a timing belt 232 looped around a pair of spaced apart timing pulleys 230 mounted on base section 150. A portion of timing belt 232 is secured to intermediate section 152 by an attachment device 240 (e.g., a mechanical fastening, an adhesive fastening, and/or a physical, chemical or metallurgical bond).

Timing belt system 222 includes a timing belt 236 looped around a pair of spaced apart timing pulleys 234 mounted on intermediate section 152. A first portion of timing belt 236 is secured to base section 150 by attachment device 242. A second portion of timing belt 236 is secured to distal section 154 by attachment device 244.

Horizontal drive unit 224 (e.g., an electric motor) is coupled to the distal timing pulley 230 of timing belt system 220. During operation, when horizontal drive unit 224 is operated to rotate distal timing pulley 230, intermediate section 152 and distal section 154 each move telescopically in or out with respect to base section 150 depending on the direction of rotation. More specifically, rotating distal timing pulley 230 of timing belt system 220 causes timing belt 236 to move. Movement of timing belt 236 causes the attached intermediate section 152 to move telescopically relative to base section 150. In turn, movement of intermediate section 152 relative to base section 150 causes corresponding telescopic movement of distal section 154 relative to intermediate section 152 via timing belt system 222.

Note that timing belt system 220 and 222 are stacked, at least partially overlapping, and driven by a single drive unit 224. This configuration is energy efficient, compact, and relatively light weight, making horizontal positioning system 122 easy to accommodate in a variety of different refuse collection vehicle configurations.

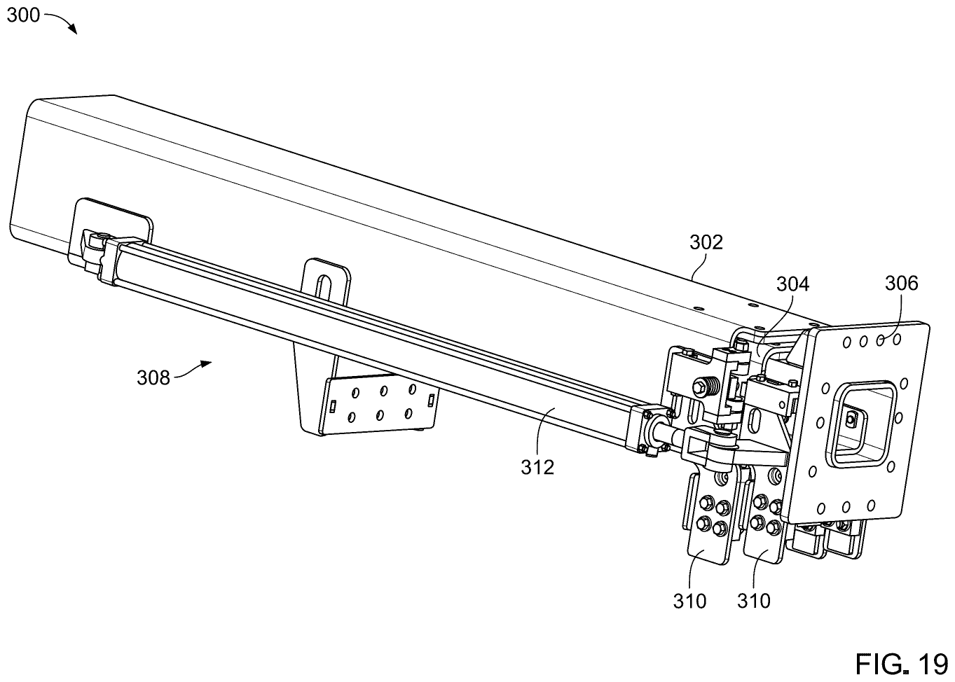

FIG. 17 illustrates a first internal roller assembly 157a that facilitates the above-discussed telescopic movement of distal section 154 relative to intermediate section 152. As shown, roller assembly 157a includes a roller carrier 264, a pair of upper rollers 262, and a lower roller 266. Roller carrier 264 is pivotally secured to distal section 154. Upper rollers 262 are rotatably mounted in roller carrier 264 and placed in contact with a top rail 263 of intermediate section 152. Lower roller 266 is coupled to roller carrier 264 by an arm 268 and configured to engage a lower rail 265 of intermediate section 152, e.g., when there is bouncing or jostling of components during use or transit. Roller assembly 157a is a rocker-type roller assembly designed to promote consistent contact between upper rollers 262 and the top rail 263 of intermediate section 152 via rocking movement of roller carrier 264.

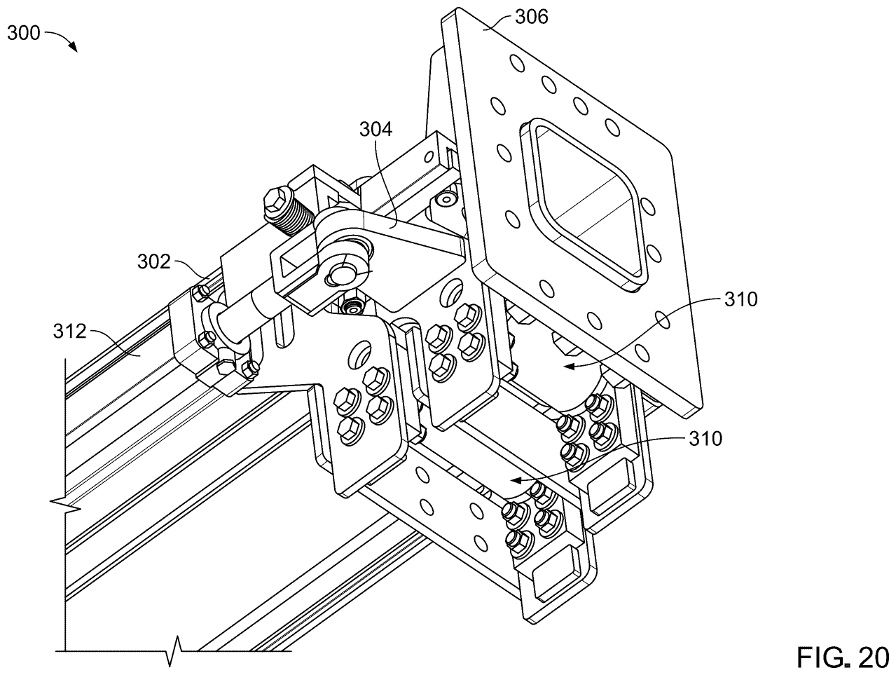

FIG. 18 illustrates a second internal roller assembly 157b that facilitates the above-discussed telescopic movement of intermediate section 152 relative to base section 150. Like roller assembly 157a, roller assembly 157b includes a roller carrier 264, a pair of upper rollers 262, and a lower roller 266. Roller carrier 264 is pivotally secured to intermediate section 152. Upper rollers 262 are rotatably mounted in roller carrier 264 and placed in contact with a top rail 267 of base section 150. Lower roller 266 is coupled to roller carrier 264 by an arm 268 and configured to engage a lower rail 269 of base section 150, e.g., when there is bouncing or jostling of components during use or transit. Roller assembly 157b is a rocker-type roller assembly designed to promote consistent contact between upper rollers 262 and the top rail 267 of base section 150 via rocking movement of roller carrier 264.

In various implementations described above, the horizontal positioning system includes structural members having a rectangular cross section. For example, in certain implementations, the movable sections are seam-welded rectangular tubes. In other implementations, a horizontal positioning system includes structural members with other cross sections. Examples include circular tubes, ovate tubes, triangular tubes, U-shaped tubes, I-beams, and/or H-beams.

In certain implementations, the horizontal positioning system described above in view of FIGS. 13-18, uses a belt drive system. A horizontal positioning system can, however, use other drive systems to move a container lift in and out with respect to the frame of a refuse collection vehicle. Examples of other drive systems include a hydraulic motor, linear actuators, chain drives, etc.

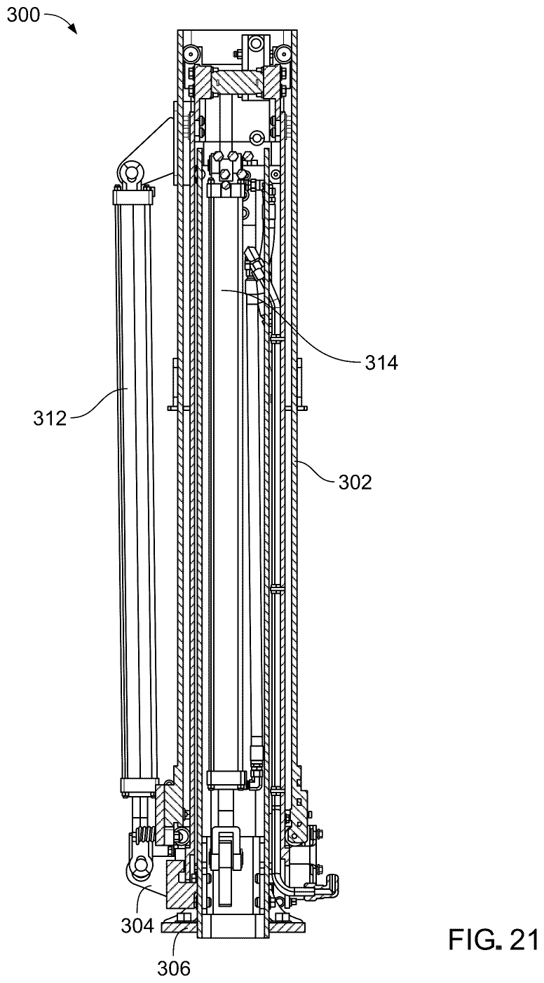

In some implementations, a horizontal positioning system includes a drive system with one or more hydraulic actuators. FIGS. 19, 20, and 21 illustrate a horizontal positioning system equipped with hydraulic actuators. Consistent with the prior implementations described above, horizontal positioning system 300 includes base section 302, intermediate section 304, and distal section 306, and drive system 308. Base section 302 and intermediate section 304 each include a set of one or more external rollers 310 and internal rollers (not shown). Intermediate section 304 rides on the set of rollers on base section 302 (See FIG. 20). Base section 302 rides on the set of rollers on intermediate section 304. Hydraulic actuator 312 (see FIGS. 19, 20, and 21) can be operated to extend and retract intermediate section 304 relative to base section 302. Hydraulic actuator 314 (see FIG. 21) can be operated to extend and retract distal section 306 relative to intermediate section 304 in same or substantially the same movement patterns described above.

Sensors can be included on various components of a refuse loading system, including, for example, a grabber device. A refuse loading system can include other sensors. For example, a refuse loading system can include load sensors, proximity switches, position sensors, angle sensors, or pressure sensors. Operation of the refuse loading mechanism or other systems can be controlled based on the information provided by the sensors. In some implementations, a refuse collection system includes sensors to sense position, angle, load or other characteristics about the system. As an example, a sensor can sense position of component of a horizontal positioning system (e.g., a distal section or an intermediate section). As another example, a sensor can sense position of a grabber system on a container lift. As another example, a grabber system can include a proximity switch that senses the position of arm of a grabber or a refuse container.

Control of a refuse collection device may be carried out manually, automatically (e.g., fully autonomously or semi-autonomously), or a combination thereof. In some implementations, a control system collects data from refuse collection system sensors and/or other operational sensors and controls the refuse collection system or other components of vehicle based on the information. For example, a control system may automatically shut down or reduce the speed of a drive system if a load (or another measured characteristic of the refuse vehicle's system) is outside an established range or exceeds an established threshold.

In some implementations, torque, speed or other parameters are adjusted based on the position, load, or other characteristics of one or more members of a refuse loading mechanism. For example, in certain implementations, the torque of the motor, energy consumption, or other operating parameters are adjusted to account for different loads. Operation of loading mechanism for collecting recycled material can, for example, be different than operation of the loading mechanism for collecting trash. In some implementations, the rate of motion of the reciprocating member can be controlled. In some implementations, a system includes interlocks to prevent unintended or un-commanded movement.

In some implementations, the control system receives position feedback from motor movement (e.g., using a sensored motor in time with the belt, position of in/out or up/down can be determined mathematically from rotation/partial rotation of motor and belt pitch).

In various implementations described above, devices are powered electrically. In certain implementations, however, devices used to operate components of a mechanism a refuse loading mechanism (such as a grabber device lift arm, or a reciprocating member) can be activated or powered in other manners, such as pneumatically, mechanically, or hydraulically.

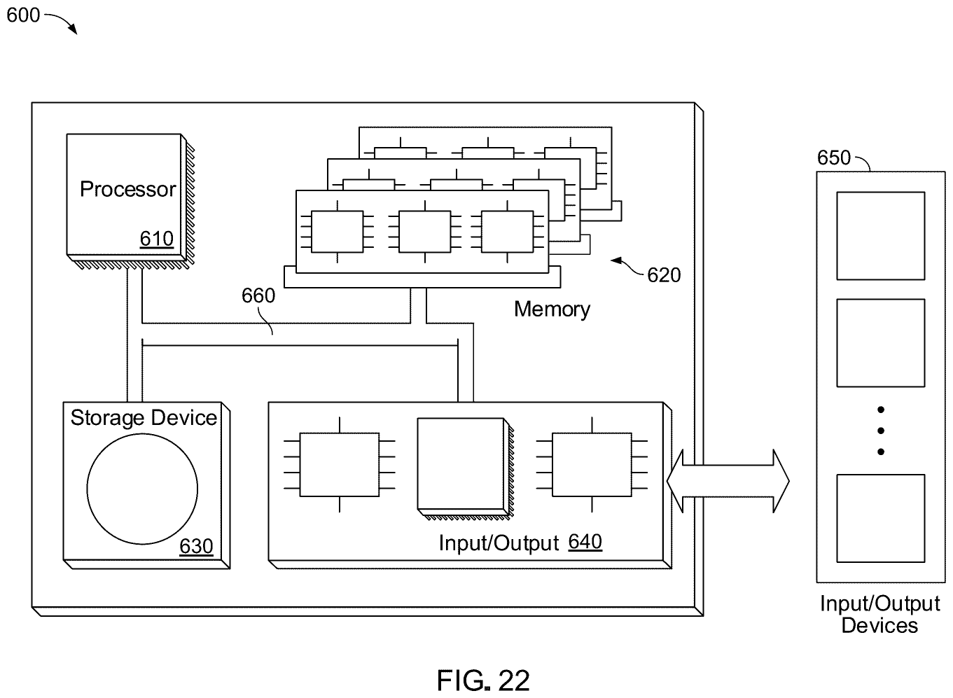

Controllers, control units and/or computing devices as described herein can include or use one or more computing systems. FIG. 22 depicts an example computing system, according to implementations of the present disclosure. The system 600 may be used for any of the operations described with respect to the various implementations discussed herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600. In some implementations, a control system may be coupled to an operator display and control panel (for example, located in a cab of the vehicle.)

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs). The system 600 may include one or more I/O devices 650.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

In various implementations described above, a system includes a timing pulley that is coupled to the output shaft of a motor. A refuse loading system can, in other implementations, include other drive unit arrangements that drive particular elements of the system. In some implementations, a drive unit includes an outrunner/hub motor arrangement. In this implementation, the rotor of the electric motor is positioned outside the stator. In some implementations, a shell of an outrunner motor as includes teeth, grooves, or other features on the outer surface of the shell that directly engage on a belt. In this case, a separate timing pulley can be omitted.

In various implementations described above, refuse loading mechanisms have been described for use on a residential automated side loader vehicle. Implementations can, however, be employed with respect to any suitable type of RCV, with any suitable type of body and/or hopper variants. For example, the RCV can be residential front loader. As another example, the RCV can be a commercial front loader (e.g., for dumpster type containers). A front loader can be provided with or without an intermediate collection device. In some implementations, a refuse lift arm as described herein automatically loads an intermediate collection device, which is then operated to transfer refuse in the intermediate collection device to another storage container on the refuse collection vehicle.

As used herein, a “drive unit” includes any device, mechanism, or system that imparts force to mechanically drive one or more components. Examples of a drive unit include a hydraulic motor, a linear actuator, an electric motor, or an engine.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of implementations have been described. Nevertheless, it will be understood that various modifications may be made without departing from the spirit and scope of the disclosure. For example, while certain of the above-described implementations employ various timing belts and pulleys, other types of flexible tethers, such as chains, bands, cables, etc. are also contemplated within the scope of this disclosure. Accordingly, other implementations are within the scope of the following claim(s).

1. A refuse lift arm system for engaging a refuse container proximate a refuse collection vehicle, the refuse lift arm system comprising:
a grabber device configured to engage the refuse container; and
a container lift comprising:
a carriage supporting pivotal movement of the grabber device;
a rail assembly supporting translational movement of the carriage;
a lift drive mechanism coupled to the carriage and the rail assembly, the lift drive mechanism configured to drive the carriage to translate along the rail assembly between a lowered position and a raised position; and
a tipping mechanism configured to pivot the grabber device relative to the carriage until the grabber device reaches a tipped condition, the tipping mechanism comprising:
a rack fixed to the rail assembly; and
a pivot gear fixed to the grabber device and rotatably mounted to the carriage, the pivot gear configured to engage the rack and rotate relative to the carriage as the carriage moves along the rail assembly toward the raised position.

2. The system of claim 1, further comprising a horizontal positioning system coupled to the rail assembly and configured to move the rail assembly laterally relative to the refuse collection vehicle.

3. The system of claim 1, wherein the pivot gear comprises a first section with a plurality of gear teeth and a second section fixed to a bracket that attaches the pivot gear to the grabber device.

4. The system of claim 1, wherein the rack comprises a plurality of rack segments, each of the plurality of rack segments comprising one or more rack teeth.

5. The system of claim 4, wherein at least one of the plurality of rack segments is removable from the rail assembly independent of at least one other of the plurality of rack segments.

6. The system of claim 1, wherein the rail assembly comprises at least one lateral bend having a tilt angle between 5 and 12 degrees relative to a vertical plane.

7. The system of claim 6, wherein the at least one lateral bend comprises two lateral bends, and wherein the tilt angle of each of the lateral bends is in the same angular direction relative to the vertical plane.

8. The system of claim 1, wherein the lift drive mechanism comprises:
a tether supported on the rail assembly and coupled to the carriage; and
a drive unit configured to drive movement of the tether relative to the rail assembly.

9. The system of claim 8, wherein the drive unit comprises an electric motor.

10. The system of claim 8, wherein:
the tether comprises a timing belt,
the timing belt is supported on the rail assembly by a pair of timing belt pulleys rotatably mounted to the rail assembly.

11. The system of claim 10, wherein:
the timing belt and the pair of timing belt pulleys are part of a first timing belt system,
the system further comprises a second timing belt system,
the drive unit is configured to simultaneously drive the first and second timing belt systems.

12. The system of claim 1, further comprising:
a sensor configured to detect relative movement of the grabber device; and
a controller configured to:
receive data from the sensor;
determine a proximity of the grabber device to at least one other component of the system; and
control operation of the lift drive mechanism based on the determined proximity.

13. The system of claim 12, wherein the controller is configured to control operation of the lift drive mechanism by reducing a speed of upward movement of the carriage along the rail assembly.

14. A method of emptying refuse from a refuse container, comprising:
holding a refuse container with a grabber device; and
while the grabber device is holding the refuse container:
moving the grabber device toward a raised position until a pivot gear engages a rack; and
tipping the grabber device by continuing to move the grabber device toward the raised position as the pivot gear rotates and traverses the rack.

15. The method of claim 14, wherein moving the grabber device toward the raised position comprises operating a drive mechanism to drive the grabber device upward while supported on a rail of a rail assembly.

16. The method of claim 14, further comprising determining a relative position of the grabber device.

17. The method of claim 16, further comprising:
determining that the pivot gear is approaching the rack based on the relative position of the grabber device; and
in response to determining that the pivot gear is approaching the rack, reducing a speed of movement of the grabber device toward the raised position.

18. A refuse lift arm system for engaging a refuse container proximate a refuse collection vehicle, the refuse lift arm system comprising:
a grabber device configured to engage the refuse container;
a container lift comprising:
a carriage supporting pivotal movement of the grabber device;
a rail assembly supporting translational movement of the carriage;
a tipping mechanism configured to pivot the grabber device relative to the carriage in response to relative movement between the carriage and the rail assembly; and
a horizontal positioning system configured to move the rail assembly laterally relative to the refuse collection vehicle, the horizontal positioning system comprising:
a base section, an intermediate section, and a distal section;
a horizontal drive mechanism comprising:
a first tether attached to the intermediate section;
a second tether attached to the base section and the distal section; and
a drive unit configured to drive movement of the first and second tethers.

19. The system of claim 18, wherein the horizontal positioning system further comprises:
a first belt system comprising:
a first pair of pulleys spaced horizontally from one another and each rotatably coupled to the base section; and
a first timing belt comprising the first tether, the first timing belt looped around the first pair of pulleys;
a second belt system comprising:
a second pair of pulleys spaced horizontally from one another and each rotatably coupled to the intermediate section; and
a second timing belt comprising the second tether, the second timing belt looped around the second pair of pulleys.

20. A refuse lift arm system for engaging a refuse container proximate a refuse collection vehicle, the refuse lift arm system comprising:
a grabber device configured to engage the refuse container;
a container lift comprising:
a carriage supporting pivotal movement of the grabber device;
a rail assembly supporting translational movement of the carriage;
a tipping mechanism configured to pivot the grabber device relative to the carriage in response to relative movement between the carriage and the rail assembly; and
a horizontal positioning system configured to move the rail assembly laterally relative to the refuse collection vehicle, the horizontal positioning system comprising:
a base section, an intermediate section, and a distal section;
a first rocker-type roller assembly residing between an upper rail and a lower rail of the intermediate section, the first rocker-type roller assembly comprising:
a first carrier pivotally secured to the distal section;
a first upper roller rotatably mounted in the first carrier and placed in contact with the upper rail of the intermediate section; and
a first lower roller coupled to the first carrier by a first arm; and
a second rocker-type roller assembly residing between an upper rail and a lower rail of the base section, the second rocker-type roller assembly comprising:
a second carrier pivotally secured to the intermediate section;
a second upper roller rotatably mounted in the second carrier and placed in contact with the upper rail of the base section; and
a second lower roller coupled to the second carrier by a second arm.
